(19) United States
(12) Patent Application Publication
(10) Pub. No.: US 2008/0307099 A1
(43) Pub. Date: Dec. 11, 2008

(54) STORAGE SYSTEM AND PRIORITY CONTROL METHOD

(75) Inventors: Atsushi UEOKA, Yokohama (JP); Takeshi ISHIZAKI, Yokohama (JP); Emiko KOBAYASHI, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/146,377

(22) Filed: Jun. 25, 2008

Related U.S. Application Data
(63) Continuation of application No. 11/195,111, filed on Aug. 1, 2005, now abandoned.

(30) Foreign Application Priority Data
Jun. 13, 2005 (JP) 2005-171878

(51) Int. Cl. G06F 15/16

(52) U.S. Cl. 709/228

(57) ABSTRACT

Provided is a priority control method for controlling a priority of data transmission in a computer system including a storage system that has a plurality of volumes, a host computer that uses the volumes, a management computer that sets a priority of data transmission between each volume and the host computer, and a network that is composed of a network device controls the priority of data transmission and provides a connection path between the storage system and the host computer. Executed in the method are a first step of obtaining from the storage system information on a first priority assigned to each volume in the storage system and a capacity of a cache memory allocated to each volume, a second step of determining a second priority of the volume on the connection path through the network by referring the obtained information, a third step of notifying the host computer of the determined second priority, a fourth step of obtaining identification of the connection path corresponding to the determined second priority of the volume, and a fifth step of setting the obtained identification to the network device.

### CLAIM OF PRIORITY

The present application claims priority from Japanese application P2005-171878 filed on Jun. 13, 2005, the content of which is hereby incorporated by reference into this application.

### BACKGROUND

This invention relates to a method of executing priority control over each volume provided in a storage system.

A storage system connected to a network (referred to also as “network storage system”) has a volume set therein, and the volume is used by a host computer through the network.

A network system communicates with the host computer via a protocol for a network connected thereto. The protocol for the network has various types, which include an internet protocol (IP). In addition, a protocol for transferring storage data by block on an IP network includes an internet small computer systems interface protocol (iSCSI).

The iSCSI is used to establish a logical session (hereinafter, referred to as “iSCSI session”) between the host computer and the storage system to create a connection. The iSCSI session can create a plurality of logical connections (hereinafter, referred to as “iSCSI connections”). The iSCSI allows access to data by use of the iSCSI connections. The use of a plurality of iSCSI connections allows network load balance and use of an alternative connection available upon occurrence of a failure.

Further, in a storage area network (hereinafter, referred to as “SAN”), various host computers use a volume of a storage system. On most of SANs, those host computers are assigned different priorities. For example, the priority of a host computer executing an important operation is higher than that of other host computers. Meanwhile, the IP network is connected from and shared by a plurality of devices, and undergoes simultaneous data transmission therebetween. Accordingly, occurrence of burst traffic may causes a loss of communication data on the network or a delay in communications. Thus, the SANs may deteriorate in access performance to a volume allocated to a given host computer, and may delay a processing to be executed by a high priority host computer.

As an example of means for solving the above problem, JP 2004-48124 A discloses a network system as follows. The network system includes a network connecting a storage system to a plurality of computers that each use the storage system. Bandwidth guarantee requirement information involved in traffic bandwidth guarantee for the network, information on an internal configuration of the storage system, and information on performance of the storage system are used to create bandwidth control information necessary for controlling bandwidths of network communications. The bandwidth control information is used to instruct a bandwidth control execution device to execute traffic bandwidth control over the network. According to the network system, bandwidths over the network can be controlled automatically.

Alternatively, JP 2003-162495 A discloses a storage subsystem having a function of selecting a communication channel in consideration of characteristics of a storage area within the storage subsystem, a characteristic of access from a host, and characteristics of the communication channel, and a function of observing a state of the communication channel as necessary to issue an instruction to add, delete, or replace the communication channel depending on the situations. The storage subsystem also has a storage subsystem control processing device including: a NIC selection processing function, a NIC information sending/receiving function, a communication channel switching function, NIC selection information, and a table showing correspondences between storage area groups and communication channel groups. According to the storage subsystem, an optimal route can be selected from a plurality of communication channels to allow bandwidth control over a network.

As described in S. Blake, and 6 others, “RFC-2475 An Architecture for Differentiated Services”, online, December 1998, IETF, Internet URL: http://www.ietf.org/rfc/rfc2475.txt, another known technique is a “differentiated services (Diffserv)”. In the Diffserv, IP addresses and their transmission control protocol (TCP) port numbers are used on an IP network to control priorities for data access. When the Diffserv is applied to a SAN, priorities on the network are set in the IP addresses of a host computer and a storage system and the TCP port number used for communications, and depending on those priorities, priorities of communication routes can be controlled.

Host computers can use a plurality of volumes having different priorities. However, in the above-mentioned prior art, the volumes used by a single host computer have the same priority. Therefore, in the storage system, access to a volume having a low priority consumes the bandwidth of the network, raising a problem in that a high priority volume cannot be used appropriately.

### SUMMARY

This invention has been made in view of the above-mentioned problem, and it is therefore an object to realize priority control over each volume provided in a storage system.

In order to achieve the above object, according to this invention, there is provided is a priority control method for controlling a priority of data transmission in a computer system including a storage system that has a plurality of volumes, a host computer that uses the volumes, a management computer that sets a priority of data transmission between each volume and the host computer, and a network that is composed of a network device controls the priority of data transmission and provides a connection path between the storage system and the host computer. Executed in the method are a first step of obtaining from the storage system information on a first priority assigned to each volume in the storage system and a capacity of a cache memory allocated to each volume, a second step of determining a second priority of the volume on the connection path through the network by referring the obtained information, a third step of notifying the host computer of the determined second priority, a fourth step of obtaining identification of the connection path corresponding to the determined second priority of the volume, and a fifth step of setting the obtained identification to the network device.

According to this invention, it is possible to establish the iSCSI connection via a TCP/IP protocol for each priority of the volume, and realize the priority control of the connection based on the priority of the volume. Accordingly, even when a single host computer uses a volume having a different priority among the volumes set in a single storage system, thereby producing an effect of preventing the network bandwidth from being consumed unnecessarily. In addition, the setting of the priority control on the network device is automated, thereby producing effects of reducing the number of setting steps required for the administrator and preventing setting errors.

### BRIEF DESCRIPTION OF THE DRAWINGS

FIG. 1 is a block diagram showing a configuration of a computer system according to an embodiment of this invention.

FIG. 2 is an explanatory diagram of an example of device information 100 according to the embodiment of this invention.

FIG. 3 is an explanatory diagram of an example of storage management information 110 according to the embodiment of this invention.

FIG. 4 is an explanatory diagram of an example of connection information 120 according to the embodiment of this invention.

FIG. 5 is an explanatory diagram of an example of a priority selection standard 150 according to the embodiment of this invention.

FIG. 6 is an explanatory diagram of an example of cache priority information 160 according to the embodiment of this invention.

FIG. 7 is an explanatory diagram of an example of connection port information 130 according to the embodiment of this invention.

FIG. 8 is an explanatory diagram of an example of volume information 140 according to the embodiment of this invention.

FIG. 9 is a flowchart of a processing for determining a priority of a volume according to the embodiment of this invention.

FIG. 10 is an explanatory diagram of an example of a priority selection standard selecting screen 400 according to the embodiment of this invention.

FIG. 11 is an explanatory diagram of an example of a priority standard selecting screen 410 according to the embodiment of this invention.

FIG. 12 is a flowchart of a processing for setting priority control information according to the embodiment of this invention.

FIGS. 13A to 13E are explanatory diagrams showing details of commands and data according to the embodiment of this invention.

FIG. 14 is a flowchart of a processing executed upon reception of a priority notification command according to the embodiment of this invention.

FIG. 15 is a flowchart of a processing executed by a control program upon access to a volume of a storage system according to the embodiment of this invention.

### DETAILED DESCRIPTION OF THE PREFERRED EMBODIMENT

Hereinafter, description will be made on an embodiment of this invention with reference to the drawings.

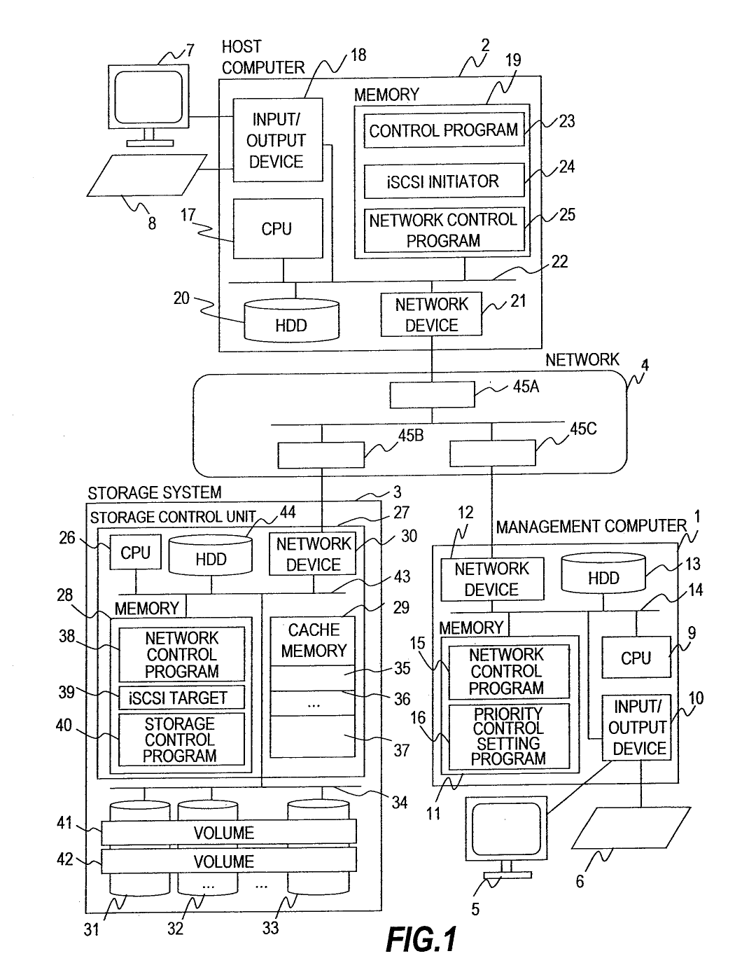

FIG. 1 is a block diagram showing a configuration of a computer system according to the embodiment of this invention.

In the computer system, a management computer 1, a host computer 2, and a storage system 3 are connected through a network 4.

The management computer 1 performs a processing relating to priority control over data transmission between the host computer 2 and the storage system 3. The host computer 2 accesses a volume provided in the storage system 3. The storage system 3 provide volumes 41 and 42 that comprises disk drives 31, 32, and 33 to the host computer 2.

The management computer 1 includes a central processing unit (CPU) 9, an input/output device 10, a memory 11, a network device 12, and a hard disk drive (HDD) 13. The components are connected to one another through a bus 14. The bus 14 is shown in FIG. 1 as a single bus, but a plurality of buses 14 may be used for the connection.

Based on parameters inputted through a keyboard 6 connected to the input/output device 10, the CPU 9 reads and executes each program stored on the memory 11. The execution results are displayed on an output display device 5.

The memory 11 stores therein a priority control setting program 16 and a network control program 15.

The network control program 15 performs data transmission through the network device 12 via a data transmission protocol. The priority control setting program 16 communicates with the host computer 2 and the storage system 3 that are connected to the network 4, and with network devices 45A to 45C composing the network 4, through the network control program 15, and then obtains priorities of volumes and allocation states of a cache memory. The priority control setting program 16 further determines the priority of each volume, and allocates the volume to the host computer 2. Further, the priority control setting program 16 sets priority control for the network devices 45A to 45C. In this embodiment, an example of using a TCP/IP data transmission protocol, but other data transmission protocols may be used.

The network device 12 is connected to the network device 45C of the network 4, and sends/receives data between the network device 45C and the management computer 1.

The HDD 13 stores therein control information. The control information includes information on the host computer 2, the storage system 3, and the network devices 45A to 45C, and also includes device information 100, storage management information 110, connection information 120, a priority selection standard 150, and cache priority information 160.

The host computer 2 uses a volume set in the storage system 3. The host computer 2 includes a central processing unit (CPU) 17, an input/output device 17, a memory 19, a hard disk drive (HDD) 20, and a network device 21. The components are connected to one another through a bus 22. The bus 22 is shown in FIG. 1 as a single bus, but a plurality of buses 22 may be used for the connection.

Based on parameters inputted through a keyboard 8 connected to the input/output device 18, the CPU 17 reads and executes each program stored on the memory 19. The execution results are displayed on an output display device 9.

The memory 19 stores therein a control program 23, an iSCSI initiator 24, and a network control program 25.

The network control program 25 performs data transmission through the network device 21 via a data transmission protocol. The iSCSI initiator 24 communicates with an iSCSI target 39 through the network control program 25 via an iSCSI protocol.

The control program 23 notifies the management computer 1 of an iSCSI connection priority based on the iSCSI protocol. Further, the control program 23 instructs the iSCSI initiator 24 to perform iSCSI connection for accessing a volume of the storage system 3.

The HDD 20 stores therein priority information relating to the priority of the iSCSI connection. The priority information includes connection port information 130.

The network device 21 is connected to the network device 45A of the network 4, and sends/receives data between the network device 45A and the host computer 2.

The network device 21 is shown in FIG. 1 as a single network device, but a plurality of network devices 21 may be connected to the network 4.

The storage system 3 provides the host computer 2 with the volumes 41 and 42 that comprises the disk drives 31, 32, and 33.

The volumes are previously assigned priorities within the storage system 3.

The storage system 3 includes a storage control unit 27 and the disk drives 31, 32, and 33. The components are connected to one another through a bus 34.

The storage control unit 27 sets the volumes of the disk drives 31, 32, and 33, and provides the volumes to the host computer 2. The storage control unit 27 includes a central processing unit (CPU) 26, a memory 28, a cache memory 29, a network device 30, and a hard disk drive (HDD) 44. The components are connected to one another through a bus 43.

The CPU 26 reads and executes each program stored on the memory 28.

The HDD 44 stores therein volume information 140 that is information on the volumes comprises the disk drives of the storage system 3.

The memory 28 stores therein a network control program 38, the iSCSI target 39, and a storage control program 40.

The network control program 38 performs data transmission through the network device 30 via a data transmission protocol. The iSCSI target 39 communicates with the iSCSI initiator 24 through the network control program 38 via the iSCSI protocol.

The storage control program 40 controls the volumes comprises the disk drives 31 to 33 of the storage system 3. The storage control program 40 notifies the management computer 1 of the priorities of volumes and the allocation states of the cache memory 29.

The cache memory 29 temporarily stores data inputted to/outputted from the volumes comprises the disk drives 31 to 33. The cache memory 29 can be logically partitioned. The storage control program 40 allocates areas 35 to 37 to the volumes 41 and 42. For example, the area 35 is allocated to the volume 41, and the area 36 is allocated to the volume 42. At this time, a given area can be used only by data to be sent to the corresponding allocation volume, and cannot be used for inputting/outputting data to be sent to another volume. In other words, the given area is occupied by the corresponding allocation volume. The capacity of the partitioned area is previously set for each corresponding allocation volume.

The network 4 includes the network devices 45A to 45C (hereinafter, referred to collectively as “network device 45”). The network device 45 transfers data to a sender device (the management computer 1, the host computer 2, or the storage control unit 27) or another network device 45 via a data transmission protocol.

The network device 45 includes a buffer used for data transmission. In IP network communications using a Diffserv, when the buffer is full of data, high priority data is sent to a destination, and low priority data is discarded from the buffer. This allows the priority control over the IP network.

In FIG. 1, the management computer 1, the host computer 2, and the storage system 3 are each connected to the network device 45 through the network 4. However, other networks may be used as long as the network can connect to those components.

Next, description will be made on details of the control information.

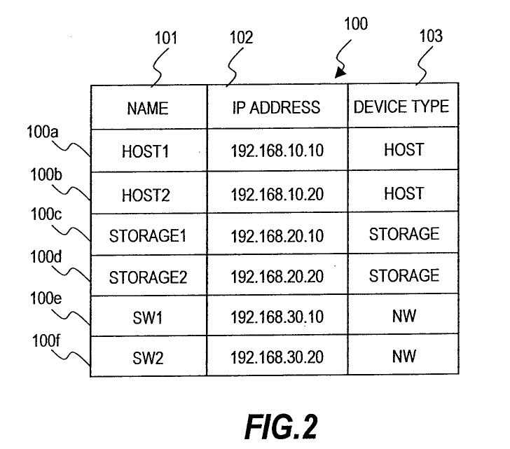

FIG. 2 is an explanatory diagram of an example of the device information 100 included in the control information. The device information 100 indicates information on the host computer 2 and the storage system 3 that are connected to the network 4, and on the network device 45 composing the network 4.

The device information 100 includes a name 101 that is an identifier for identifying a given device, an IP address 102 indicating an IP address of the device, and a device type 103 indicating a type of the device. The device type 103 is represented as “HOST” for the host computer 2, “STORAGE” for the storage system 3, and “NW” for the network device 45.

The device information 100 stores therein device records 100a to 100f. For example, the device record 100a indicates a host computer 2 having “HOST1” as the name and “192.168.10.10” as the IP address.

The priority control setting program 16 of the management computer 1 references the device information 100 to obtain the IP address of each device.

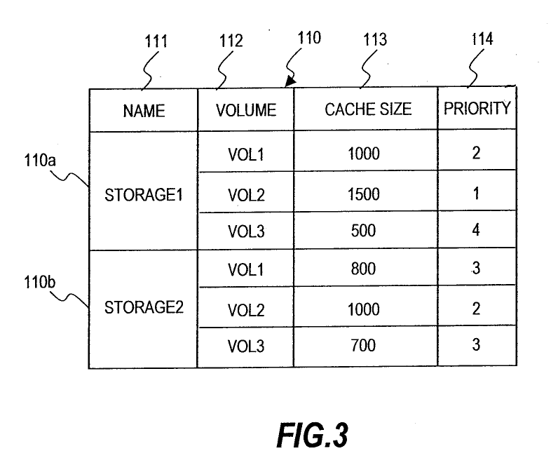

FIG. 3 is an explanatory diagram of an example of the storage management information 110 included in the control information. The storage management information 110 indicates information on the volumes set in the storage system 3.

The storage management information 110 includes a name 111 that is an identifier of a given storage system 3, a volume 112 that is an identifier of a given volume of the storage system 3, a cache size 113 indicating a size of a cache memory allocated to the volume, and a priority 114 indicating a priority of the volume.

The storage management information 110 stores therein records 110a and 110b. For example, it is indicated in the record 110a that a storage system 3 whose name is “STOARAGE1” includes three volumes “VOL1”, “VOL2”, and “VOL3”, and the sizes of cache memories allocated to the volumes are “1000”, “1500”, and “500”, respectively. It is also indicated that the priorities of the volumes “VOL1”, “VOL2”, and “VOL3” are “2”, “1”, and “4”, respectively.

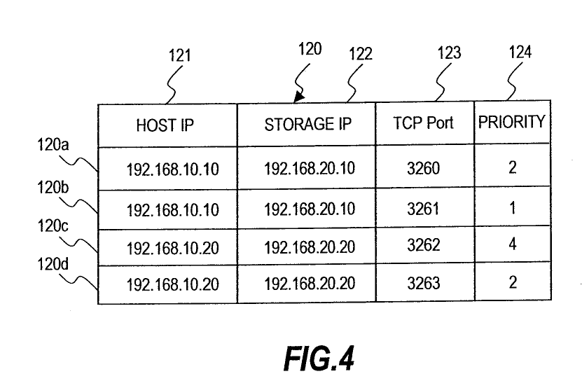

FIG. 4 is an explanatory diagram of an example of the connection information 120 on connections between the host computers 2 and the storage systems 3, which is included in the control information.

The connection information 120 includes a HOST IP 121 indicating an IP address of a given host computer 2, a STORAGE IP 122 indicating an IP address of a given storage system 3, a TCP Port 123 indicating a TCP port number used by the host computer 2 for connecting to the storage system 3, and a priority 124 indicating a priority set for the TCP port number.

The connection information 120 stores therein records 120a to 120d. For example, the record 120a indicates a host computer 2 whose IP address is “192.168.10.10” and a storage system 3 whose IP address is “192.168.20.10”. It is indicated that the TCP port number used by the host computer 2 is “3260” and the corresponding priority is “2”.

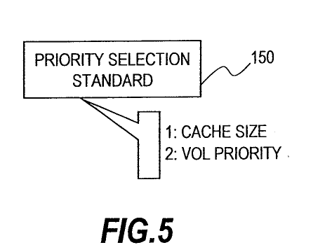

FIG. 5 is an explanatory diagram of an example of the priority selection standard 150 included in the control information.

In the example of FIG. 5, with the priority selection standard value being “1”, the priority of a given volume is to be determined based on the cache size. With the priority selection standard value being “2”, the priority of a given volume set in the storage system 3 is to be used as it is.

The priority control setting program 16 references the settings of the priority selection standard 150 to determine the priority of the volume based on the priority selection standard value obtained or calculated. As a result, the priority control setting program 16 judges whether the priority of the volume set in the storage system 3 is to be used or the priority is to be determined based on the cache size allocated to the volume.

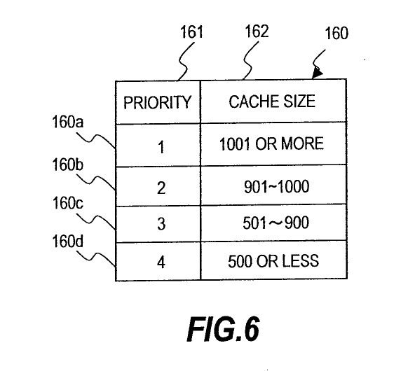

FIG. 6 is an explanatory diagram of an example of the cache priority information 160 included in the control information. The cache priority information 160 indicates correspondences between cache sizes allocated to volumes and their priorities.

The cache priority information 160 includes a priority 161 and a cache size 162 indicating a capacity of a cache memory corresponding to the priority 161.

The cache priority information 160 stores therein records 160a to 160d. For example, the record 160a indicates that when the capacity of a cache memory allocated to a given volume is 1001 or more, the priority of the volume is “1”. The record 160b indicates that when the capacity of a cache memory allocated to another given volume is 901 to 1000, the priority of the volume is “2”.

Next, description will be made on details of the priority information.

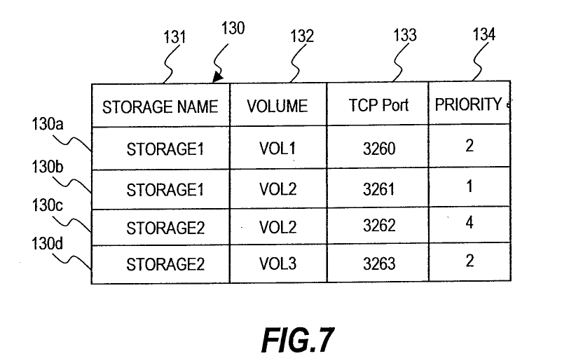

FIG. 7 is an explanatory diagram of an example of the connection port information 130 composing the priority information stored in the host computer 2.

The connection port information 130 stores therein a TCP port number used by a given host computer 2 for connecting to a given storage system 3, the corresponding priority, and the like.

The connection port information 130 includes a STORAGE name 131 that is an identifier of a storage system 3 connected from a given host computer 2, a volume 132 that is an identifier of a given volume used by the host computer 2, a TCP Port 133 indicating a TCP port number used by the host computer 2 for using the volume, and a priority 134 indicating a priority of the volume.

The connection port information 130 stores therein records 130a to 130d. For example, the record 130a indicates that the TCP port number for using the volume “VOL1” of the storage system “STORAGE1” is “3260” and the corresponding priority is “2”.

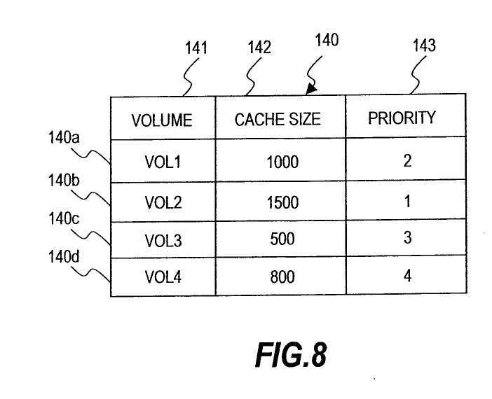

FIG. 8 is an explanatory diagram of an example of the volume information 140 stored in the storage control unit 27.

The volume information 140 stores therein information on a volume set in a given storage system 3. The storage control unit 27 previously sets the volume, and stores information thereon in the volume information 140.

The volume information 140 includes a volume 141 indicating a name of a volume existing in the storage system 3, a cache size 142 indicating a size of a cache memory allocated to the volume, and a priority 143 indicating a priority of the volume within the storage system 3.

The volume information 140 stores therein records 140a to 140d. For example, the record 140a indicates that the capacity of the cache memory allocated to a volume whose name is “VOL1” is “1000”, and the priority of the volume within the storage system 3 is “2”.

Next, description will be made on a priority control method according to this invention.

The priority control is implemented by the priority control setting program 16 of the management computer 1 and the control program 23 of the host computer 2.

First, description will be made on a priority setting processing executed by the priority control setting program 16.

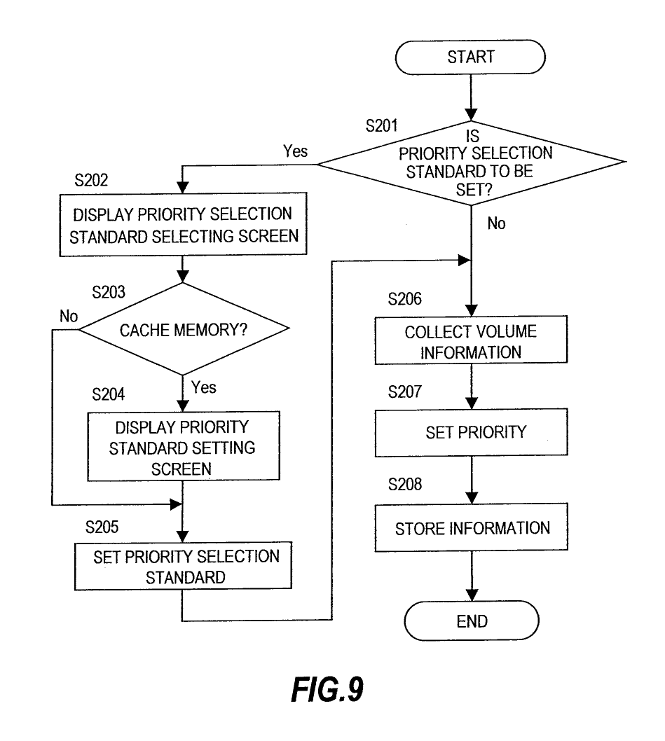

FIG. 9 is a flowchart of a processing for determining the priority of a volume, executed by the priority control setting program 16.

An administrator of the system or the like uses a keyboard 6 to input an instruction for priority setting. In response to the instruction, the priority control setting program 16 starts the processing.

First, the priority control setting program 16 judges whether or not a command inputted through the keyboard 6 is a command to set the priority selection standard 150 (S201). In the case where the command is not a command to set the priority selection standard 150, the processing advances to step S206 to set the priority without setting the priority selection standard 150.

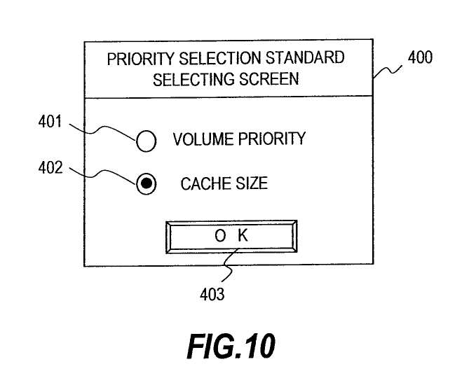

In the case where the command is a command to set the priority selection standard 150, the processing advances to step S202 to display a priority selection standard selecting screen 400 shown in FIG. 10 through the input/output device 10.

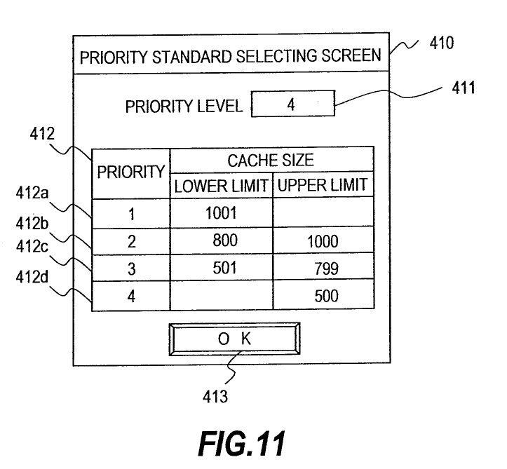

Then, the priority control setting program 16 makes judgment on the contents selected on the priority selection standard selecting screen 400. To be specific, the priority control setting program 16 judges whether a priority assigned to a given volume set in the storage system 3 is to be used or the priority is to be determined based on the capacity of the cache memory allocated to the volume. When it is judged according to selection by the administrator that the priority of the volume is to be used, the processing advances to step S205 to set the priority selection standard 150 to “2”. When it is judged according to the selection by the administrator that the priority is to be determined based on the capacity of the cache memory, the processing advances to step S204 to display a priority standard selecting screen 410 shown in FIG. 11. The administrator uses the screen to set the priority based on the cache memory. After that, the priority control setting program 16 stores the set contents in the cache priority information 160, and further sets the priority selection standard 150 to “1” (S205).

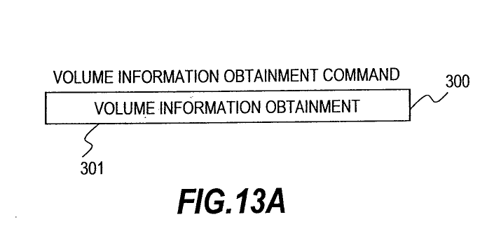

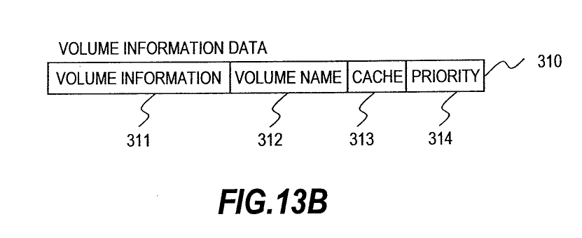

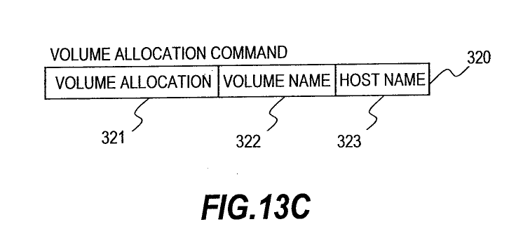

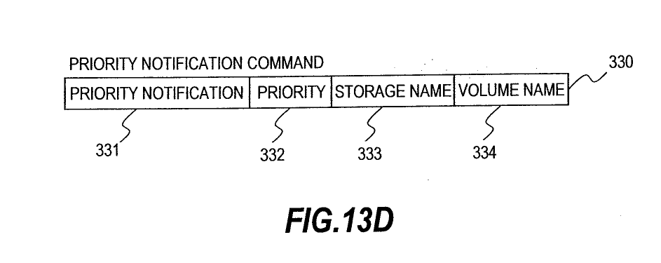

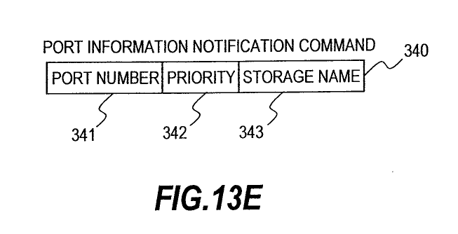

Then, the priority control setting program 16 collects information on the volume from the storage system 3. To be specific, the priority control setting program 16 retrieves a record with the device type 103 being “STORAGE” from the device information 100 of the control information, obtains its IP address, and sends a volume information obtainment command 300 shown in FIG. 13A to the storage system 3 at the IP address. When there exist a plurality of storage systems 3, volume information obtainment commands 300 corresponding to the number of the storage systems 3 are sent.

Upon reception of the command, the storage control program 40 of the storage control unit 27 references the information of the volume information 140 to create volume information data 310 shown in FIG. 13B, and sends the created volume information data 310 to the sender management computer 1. The priority control setting program 16 obtains the sent data.

The priority control setting program 16 obtains the information from the volume information data 310, and determines the priority of each volume obtained (S207).

For example, when the priority selection standard 150 is set to “2” in the step S205, the priority of the volume indicated in the received volume information data 310 is to be used as the priority for priority control. When the priority selection standard 150 is set to “1”, the capacity of the cache memory indicated in the received volume information data 310 is to be used along with the contents of the cache priority information 160 for determination of the priority of the volume.

Then, the priority control setting program 16 stores the priority determined in the step S207 in the storage management information 110 of the control information. In other words, the priority control setting program 16 creates a record for each storage system 3 that has received the volume information data 310, and stores in the record the received volume name, the cache size allocated to the volume, and the priority determined in the step S207. The processing is then ended.

The above-mentioned processing determines the priorities of all the volumes set in the storage system 3 in terms of the network.

FIG. 10 is an explanatory diagram of an example of the priority selection standard selecting screen 400.

The priority selection standard selecting screen 400 is a screen for prompting the administrator to make a selection as to whether the priority assigned to the volume set in the storage system 3 is to be used or the priority is to be determined based on the capacity of the cache memory allocated to the volume.

To use the priority of the volume within the storage system 3, the administrator selects a volume priority 401 and then operates a button 403. To determine the priority based on the capacity of the cache memory allocated to the volume, the administrator selects a cache size 402 and then operates the button 403.

FIG. 11 is an explanatory diagram of an example of the priority standard selecting screen 410.

The priority standard selecting screen 410 includes an area 411 for entry of a priority level, a table 412 for setting the capacity of a cache memory for respective priorities, and a button 413.

In the example of FIG. 11, “4” is entered in the area 411, meaning that the priority level is set to 4. The lower limit of the capacity of a cache memory with the priority being “1” is set to “1001”. The capacity of a cache memory with the priority being “2” has the upper limit set to “1000” and the lower limit set to “800”.

When the priority standard is inputted through the screen in the step S204 of FIG. 9, in the step S205 of FIG. 9, the priority control setting program 16 stores the inputted priority standard in the cache priority information 160, and sets the priority selection standard 150 to “1”.

Next, description will be made on a processing for setting the priority control information in the network device 45 composing the network 4.

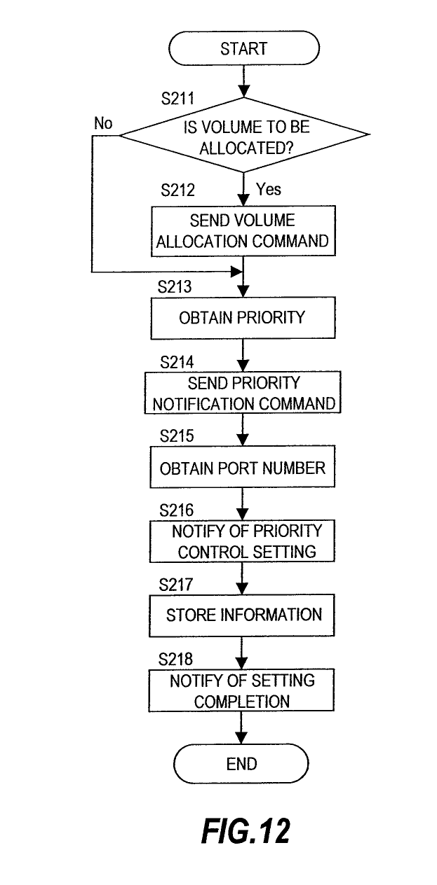

FIG. 12 is a flowchart of a processing for setting priority control information in the network device 45 composing the network 4, executed by the priority control setting program 16.

The processing is executed when the processing of FIG. 9 undergoes a change in the contents of the priority selection standard 150 or the cache priority information 160, or new allocation of a volume to the host computer 2.

First, the priority control setting program 16 judges whether or not a new volume is to be allocated to the host computer 2 (S211). In the case where the new volume is not to be allocated, in other words, the case where the processing of FIG. 9 has already been executed on the volume, the processing advances to a step S213. In the case where the new volume is to be allocated, in a step S212, the priority control setting program 16 sends volume allocation command shown in FIG. 13C to the host computer 3. The host computer 2 notified of the command can use the volume relating to the command of the storage system 3.

Then, the priority control setting program 16 obtains the priority of the newly allocated volume, or of the volume assigned a priority by the processing of FIG. 9, from the storage management information 110 of the control information (S213). The priority control setting program 16 sends a priority notification command 330 shown in FIG. 13D to the host computer 2 to which a new volume is allocated or the host computer 2 to use the volume assigned a priority (S214).

Upon reception of the priority notification command 330, the host computer 2 sends a port information notification command 340 shown in FIG. 13E to the management computer 1. The priority control setting program 16 references the port information notification command 340 sent from the host computer 2, and obtains TCP port numbers used with respective priorities (S215).

The TCP port number is an identification of a path over the network 4. An iSCSI connection is established for each TCP port number.

Then, the priority control setting program 16 obtains the IP addresses of the host computer 2 and the storage system 3 from the device information 100 of the control information. Based on the IP addresses, and the priorities and the TCP port number obtained in the step S215, the priority control setting program 16 notifies each network device 45 of a set of the IP addresses of the host computer 2 and the storage system 3, the TCP port number used by the host computer 2, and the priority, as priority control settings (S216). The notification is made by using a protocol such as a routing information protocol (RIP) or a simple network management protocol. The notified information is stored as the record of the connection information 120 (S217).

Finally, the priority control setting program 16 notifies the host computer 2 of the setting completion relating to the network device 45 (S218), and ends the processing.

According to the above-mentioned processing, the host computer 2 is notified of the priority of a given volume. The volume is set for the network device 45 used for priority control over the network.

FIGS. 13A to 13E are explanatory diagrams showing details of commands and data that are sent by the priority control setting program 16 of the management computer 1, the control program 23 of the host computer 2, and the storage control program 40 of the storage control unit 27.

FIG. 13A shows the volume information obtainment command 300. The volume information obtainment command 300 includes a volume information obtainment 301 for instructing a target to send the volume information.

FIG. 13B shows the volume information data 310. The volume information data 310 includes an identifier 311 indicating the type of data to be sent, a volume name 312 indicating the name of a given volume, a cache 313 indicating the capacity of a cache memory allocated to the volume, and a priority 314 indicating the priority within the storage system 3 including the volume. The identifier 311 stores therein “volume information” indicating identification of the volume information data.

FIG. 13C shows a volume allocation command 320. The volume allocation command 320 includes an identifier 321 indicating the type of data to be sent, a volume name 322 indicating a volume to be allocated, and a HOST name 323 indicating the name of a host computer 2 to which the volume is to be allocated. The identifier 321 stores therein “volume allocation” indicating instruction for the allocation of a volume. The volume name 322 stores therein the name of the volume to be allocated, and the HOST name 323 stores therein the name of the host computer 2 to which the volume is to be allocated.

FIG. 13D shows the priority notification command 330. The priority notification command 330 includes an identifier 331 indicating the type of data to be sent, a priority 332 indicating the priority of a given volume, a storage name 333 indicating the name of the storage system 3, and a volume name 334 indicating the volume. The identifier 331 stores therein “priority notification” indicating notification of the priority of a volume. The priority 332 stores therein the priority of the volume, the storage name 333 stores therein the name of the storage system 3 providing the volume, and the volume name 334 stores therein the name of the volume.

FIG. 13E shows the port information notification command 340. The port information notification command 340 includes a port number 341 indicating a TCP port number, a priority 342 indicating a priority assigned to the TCP port number, and a storage name 343 indicating the name of the storage system 3. The host computer 2 uses the TCP port number stored in the port number 341 to execute data transmission with the volume of the storage system 3 indicated in the storage name 343 based on the priority indicated in the priority 342.

Next, description will be made on a processing executed by the host computer 2.

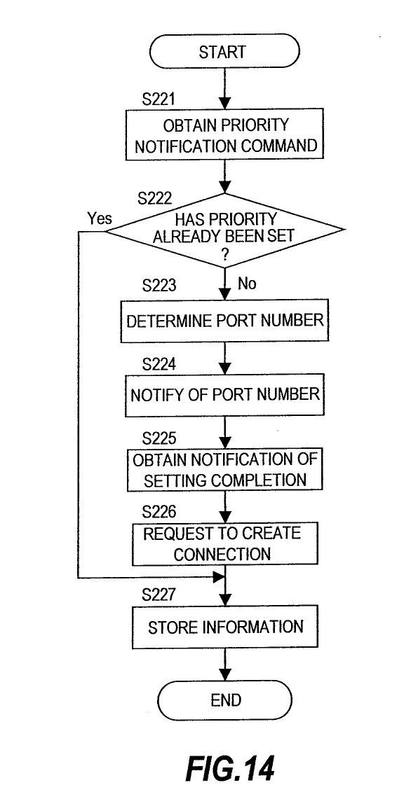

FIG. 14 is a flowchart of a processing executed when the control program 23 of the host computer 2 receives the port information notification command 340 from the priority control setting program 16 of the management computer 1 (S214 of FIG. 12).

Upon reception of the priority notification command 330 (S221), the control program 23 references a storage system 3 indicated in the storage name 333 of the priority notification command 330 and a priority indicated in the priority 332 thereof. Then, the control program 23 references the record of the connection port information 130 to judge whether or not the priority has already been set and a connection using the priority has been established with regard to the storage system 3 (S222).

In the case where the priority has already been set and the connection using the priority has been established with regard to the storage system 3, the control program 23 advances the processing to a step S227 to store information relating thereto as the connection port information 130, and then ends the processing. Meanwhile, in the case where the priority has not yet been set with regard to the storage system 3, the control program 23 advances the processing to a step S223 to retrieve an unused TCP port number. Then, the control program 23 determines a TCP port number for connecting to the storage system 3 indicated in the priority notification command 330 based on the information indicated in the priority notification command 330.

Then, the control program 23 sends the port information notification command 340 to the priority control setting program 16 of the management computer 1, and notifies the priority control setting program 16 of the priority and the determined TCP port number (S224).

After that, when notified of the setting completion of the priority control relating to the network device 45 from the priority control setting program 16 of the management computer 1 in the step S218 of FIG. 12, the control program 23 uses the TCP port number determined in the step S223 to send to the iSCSI initiator 24 a request to establish an iSCSI connection to the storage system 3 indicated in the priority notification command 330. Upon reception of the request, the iSCSI initiator 24 establishes the iSCSI connection.

Finally, the control program 23 adds the storage name, the volume name, the TCP port number, and the priority to the connection port information 130 of the priority information, and ends the processing.

According to the above-mentioned processing, the host computer 2 is assigned with the TCP port number for each priority set in the volume. The allocated TCP port number is used to establish the iSCSI connection with the storage system 3.

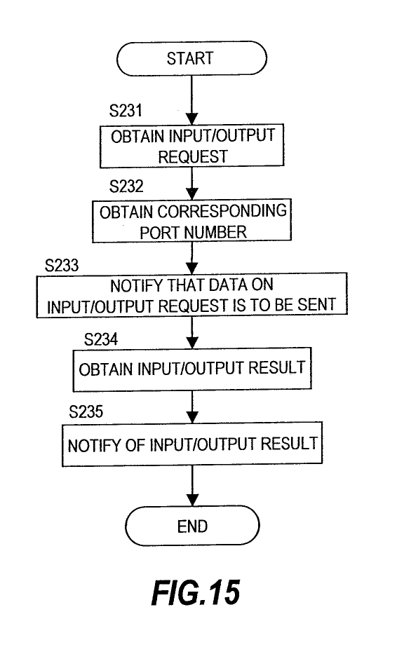

FIG. 15 is a flowchart of a processing executed by the control program 23 executed when the host computer 2 accesses to a volume of the storage system 3.

In the host computer 2, an instruction is issued by the administrator through the keyboard 8 or issued from another program to make a request to input to/output with respect to a volume of the storage system 3.

Upon obtaining the input to/output request with respect to the volume (S231), the control program 23 obtains the TCP port number for accessing the volume according to the request from the connection port information 130 of the priority information (S232).

Then, the control program 23 uses the iSCSI connection at the TCP port number obtained in the step S232 to notify the iSCSI initiator 24 that data on the input/output request obtained in the step S231 is sent to a request target volume.

In response, the iSCSI initiator 24 uses the iSCSI at the TCP port number to send data to the volume of the storage system 3.

After obtaining results of the input/output request from the iSCSI initiator 24 (S234), the control program 23 notifies a request issuer of the input/output request obtained in the step S231 of the results (S235), and ends the processing.

The above-mentioned processing completes the access to the volume using the iSCSI connection based on the priority of the volume on which the input/output request has been made.

At this time, as described above, the network device 45 of the network 4 executes the priority control over the IP network using the Diffserv. Accordingly, the priority control information can be realized on the host computer 2.

As has been described above, according to this invention, the iSCSI connection is established between the host computer 2 using the volume and the storage system 3 according to the priority of the volume set within the storage system 3 or the priority determined based on the capacity of the logically partitioned area of the cache memory allocated to the volume. Further, the IP addresses of the host computer 2 and the storage systems 3 and the TCP port number used by the host computer 2 at each priority are set in the network device 45 composing the network 4. Based on the information, the network device 45 executes the priority control using the Diffserv on an iSCSI connection basis.

According to this configuration, even when a single host computer 2 uses the plurality of volumes 41 and 42 provided in a single storage system 3, the priority control can be performed over the network 4 based on the priorities of the volumes 41 and 42, thereby allowing reduction in the network bandwidth consumed by the low priority volume.

In addition, the setting of the priority control on the network device is automated, thereby producing effects of reducing the number of setting steps required for the administrator and preventing setting errors.

While the present invention has been described in detail and pictorially in the accompanying drawings, the present invention is not limited to such detail but covers various obvious modifications and equivalent arrangements, which fall within the purview of the appended claims.

1. A priority control method for controlling a priority of data transmission in a computer system including:
a storage system that has a plurality of volumes;
a host computer that uses the volumes;
a management computer that sets a priority of data transmission between each volume and the host computer; and
a network device that controls a priority of a connection path between the storage system and the host computer, the method comprising:
a first step of obtaining, from the storage system, information on a first priority assigned to each volume in the storage system and a capacity of a cache memory allocated to each volume, wherein the first priority is previously assigned to the each volume within the storage system;
a second step of determining a second priority of the volume on the connection path by referring the obtained information, wherein the second priority of the volume is determined based on the capacity of the cache memory allocated to the volume or the first priority assigned to the volume, and wherein the capacity of the cache memory allocated to the volume is a size of the cache memory;
a third step of notifying the host computer of the determined second priority;
a fourth step of obtaining identification of the connection path corresponding to the determined second priority of the volume; and
a fifth step of setting the obtained identification to the network device.

2. The priority control method according to claim 1, further comprising:
a sixth step of determining the identification on the connection path corresponding to the second priority of the volume;
a seventh step of notifying the management computer of the second priority and the determined identification;
an eighth step of establishing the connection path between the host computer and the storage system by referring the second priority and the determined identification; and
a ninth step of using the connection path corresponding to the second priority of the volume upon transmitting data to the volume of the storage system.

3. (canceled)

4. The priority control method according to claim 2, wherein:
the network device uses an iSCSI as a data transmission protocol;
the identification on the connection path is identification on an iSCSI connection path; and
the eighth step includes establishing the iSCSI connection path between the host computer and the storage system by referring the second priority and the determined identification.

5. The priority control method according to claim 4, wherein the ninth step includes using the iSCSI connection corresponding to the second priority of the volume upon transmitting data to the volume of the storage system.

6. A computer system, comprising:
a storage system that has a plurality of volumes;
a host computer that uses the volumes;
a management computer that sets a priority of data transmission between each volume to the host computer; and
a network device that controls a priority of a connection path between the storage system and the host computer, wherein:
the management computer obtains from the storage system information on a first priority assigned to each volume in the storage system and a capacity of a cache memory allocated to each volume, wherein the first priority is previously assigned to the each volume within the storage system;
the management computer:
determines a second priority of the volume on the connection path through the network device by referring the obtained information, wherein the second priority of the volume is determined based on the capacity of the cache memory allocated to the volume or the first priority assigned to the volume, and wherein the capacity of the cache memory allocated to the volume is a size of the cache memory;
notifies the host computer of the determined second priority;
obtains from the host computer identification of the connection path corresponding to the determined second priority of the volume; and
sets the obtained identification to the network device.

7. The computer system according to claim 6, wherein the host computer:
determines the identification on the connection path corresponding to the second priority of the volume;
notifies the management computer of the second priority and the determined identification;
establishes the connection path between the host computer and the storage system by referring the second priority and the determined identification; and
uses the connection path corresponding to the second priority of the volume upon transmitting data to the volume of the storage system.

8. (canceled)

9. The computer system according to claim 7, wherein:
the network device uses an iSCSI as a data transmission protocol;
the identification on the connection path is identification on an iSCSI connection path; and
the host computer establishes the iSCSI connection path between the host computer and the storage system by referring the second priority and the determined identification.

10. The computer system according to claim 9, wherein the host computer uses the iSCSI connection path corresponding to the second priority of the volume upon transmitting data to the volume of the storage system.

11. A management computer that sets a priority of data transmission with each volume used by the host computer and connects through a network to each of:
a storage system that has a plurality of volumes;
a host computer that uses the volumes;
a network device that controls a priority of a connection path between the storage system and the host computer,
the management computer comprising:
a communication interface that connects to the network; and
a processor unit that is connected to the communication interface, wherein the processor unit:
obtains, through the communication interface from the storage system, information on a first priority assigned to each volume in the storage system and a capacity of a cache memory allocated to each volume, wherein the first priority is previously assigned to the each volume within the storage system;
determines a second priority of the volume on the connection path through the network device by referring the obtained information, wherein the second priority of the volume is determined based on the capacity of the cache memory allocated to the volume or the first priority assigned to the volume, and wherein the capacity of the cache memory allocated to the volume is a size of the cache memory;
notifies the management computer of the determined second priority through the communication interface;
obtains through the communication interface from the host computer identification on the connection path corresponding to the determined second priority of the volume; and
sets the obtained identification to the network device through the communication interface.

12. (canceled)

13. The management computer according to claim 11, wherein:
the network device uses an iSCSI as a data transmission protocol;
and the identification on the connection path is identification on an iSCSI connection path.

14. A method for controlling a priority of a connection path between a storage system and a host computer, the method comprising:
receiving a user input for setting a priority selection standard;
if the user input indicates to use a previously assigned priority of a volume,
obtaining priority information of each volume in the storage system, and determining the priority of the volume on the connection path based on the obtained priority information;
if the user input indicates to use a cache capacity for setting the priority selection standard,
determining the priority of the volume on the connection path based on a capacity of the cache memory allocated to the volume, wherein the capacity of the cache memory allocated to the volume is a size of the cache memory;
notifying the host computer of the determined priority;
obtaining identification of the connection path corresponding to the determined priority of the volume; and
setting the obtained identification to the network device.

15. The method according to claim 14, further comprising:
determining the identification on the connection path corresponding to the determined priority of the volume;
notifying the management computer of the determined priority and the determined identification;
establishing the connection path between the host computer and the storage system by referring the determined priority and the determined identification; and
using the connection path corresponding to the determined priority of the volume upon transmitting data to the volume of the storage system.
